(19) United States
(12) Patent Application Publication
(10) Pub. No.: US 2023/0351851 A1
(43) Pub. Date: Nov. 2, 2023

(54) PROVIDING BOOSTS FOR MULTIPLE GAMES WITHOUT ALTERING RETURN TO PLAYER

(71) Applicant: Aristocrat Technologies, Inc., Las Vegas, NV (US)

(72) Inventors: Jack Ahern, San Francisco, CA (US); Andrew Pedersen, San Francisco, CA (US); Chad La Guardia, Austin, TX (US)

(21) Appl. No.: 17/955,838

(22) Filed: Sep. 29, 2022

Related U.S. Application Data
(60) Provisional application No. 63/335,594, filed on Apr. 27, 2022.

(51) Int. Cl. G07F 17/32; G07F 17/34

(52) U.S. Cl. CPC G07F 17/3267; G07F 17/34

(57) ABSTRACT

A boost framework provides boosts that may be used in multiple different games, but enables the effect of the boosts to be respectively defined in each of the different games. Each of the multiple different games defines at least a base game mode and one or more boost game modes that one or more amounts of boosts may be used to activate. In this way, boosts may be provided for multiple different games without altering the return to player that has been respectively defined by each of the multiple games.

### CROSS-REFERENCE TO RELATED APPLICATION

This application is a nonprovisional and claims the benefit under 35 U.S.C. 119(e) of U.S. Provisional Patent Application No. 63/335,594, filed Apr. 27, 2022, the contents of which are incorporated herein by reference in their entirety as if fully disclosed herein.

### BACKGROUND

Electronic gaming machines (“EGMs”) or gaming devices provide a variety of wagering games such as slot games, video poker games, video blackjack games, roulette games, video bingo games, keno games, and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens, or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

The present disclosure provides boosts that may be used in multiple different games, but enables the effect of the boosts to be respectively defined in each of the different games. Each game may define a base game mode and one or more boost game modes that one or more amounts of boosts may be used to activate. In this way, boosts may be provided for multiple different games without altering the return to player that has been respectively defined by each of the multiple games.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts a first example method for providing boosts for multiple games without altering return to player. The method may be performed by one or more of the devices depicted in FIGS. 1-3.

FIG. 5 depicts a second example method for providing boosts for multiple games without altering return to player. The method may be performed by one or more of the devices depicted in FIGS. 1-3.

FIG. 6 depicts a third example method for providing boosts for multiple games without altering return to player. The method may be performed by one or more of the devices depicted in FIGS. 1-3.

FIG. 7A depicts a lobby of a virtual casino environment that is operable to provide access to multiple games that are operable to use boosts and at least one boost providing game.

FIG. 7B depicts a lobby of the boost providing game.

FIG. 7C depicts play of the boost providing game.

FIG. 7D depicts a first screen of the boost providing game providing a boost.

FIG. 7E depicts a second screen of the boost providing game providing a boost.

FIG. 7F depicts a boost inventory screen accessed from the lobby of the boost providing game depicted in FIG. 7B.

FIG. 7G depicts play of a game of the multiple games that is operable to use boosts.

FIG. 7H depicts a boost inventory screen accessed from the game depicted in FIG. 7G.

FIG. 7I depicts a boost game mode of the game depicted in FIG. 7G.

FIG. 7J depicts a boost game mode summary at the end of the boost game mode depicted in FIG. 7I.

### DETAILED DESCRIPTION

Providing boosts that may be used to affect play of multiple games, such as multiple different slot type games, may improve the chase that the players of the multiple games experience as boost game mode versions of the games may be more thrilling than base game mode versions of the games. This may also be used to increase interest in another game that does not use the boosts but instead provides them, and/or an environment that includes the multiple games and the other, boost providing, game. However, each of the multiple games may have its own defined return to player and providing boosts with defined effects to games with defined return to players may alter those return to players. This may be prohibited by one or more laws, regulations, and so on.

The present disclosure provides boosts that may be used in multiple different games, but enables the effect of the boosts to be respectively defined in each of the different games. Each game may define a base game mode and one or more boost game modes that one or more amounts of boosts may be used to activate. In this way, boosts may be provided for multiple different games without altering the return to player that has been respectively defined by each of the multiple games.

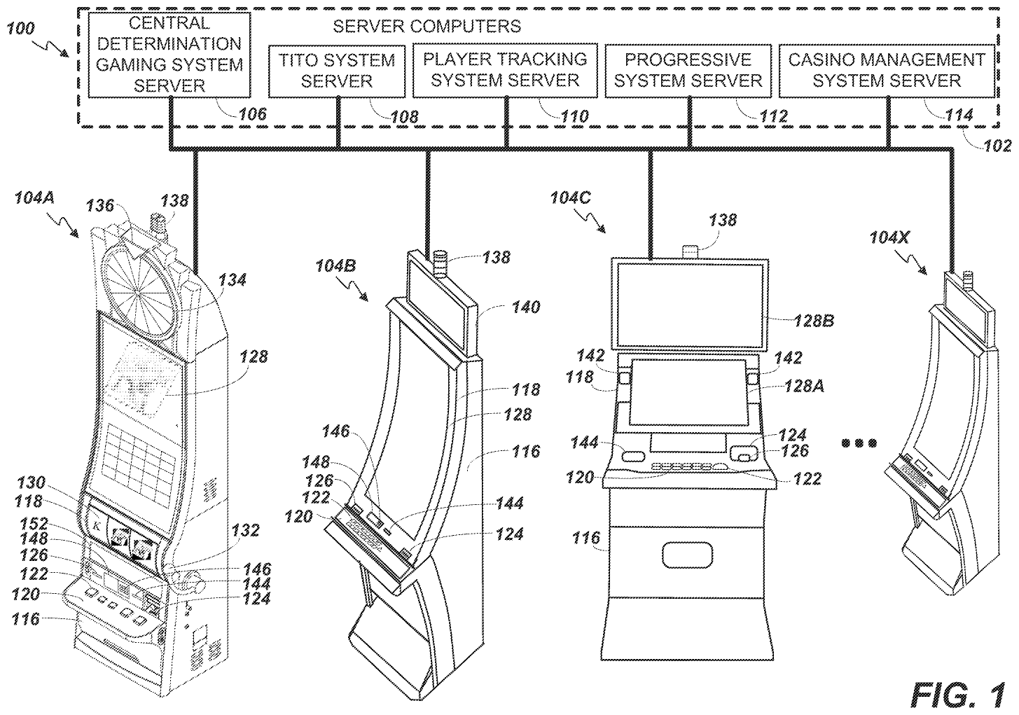

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

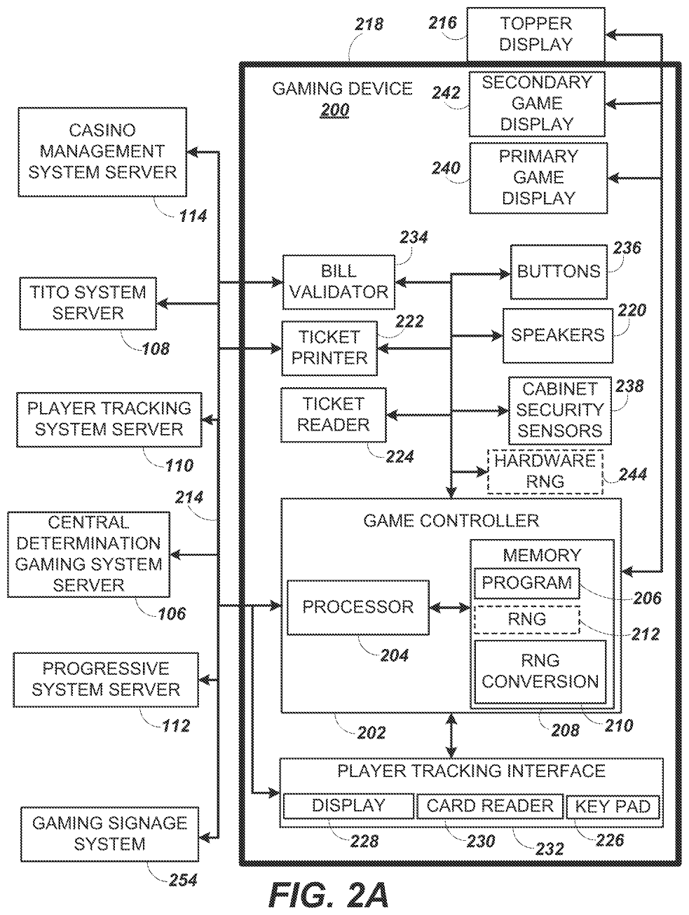

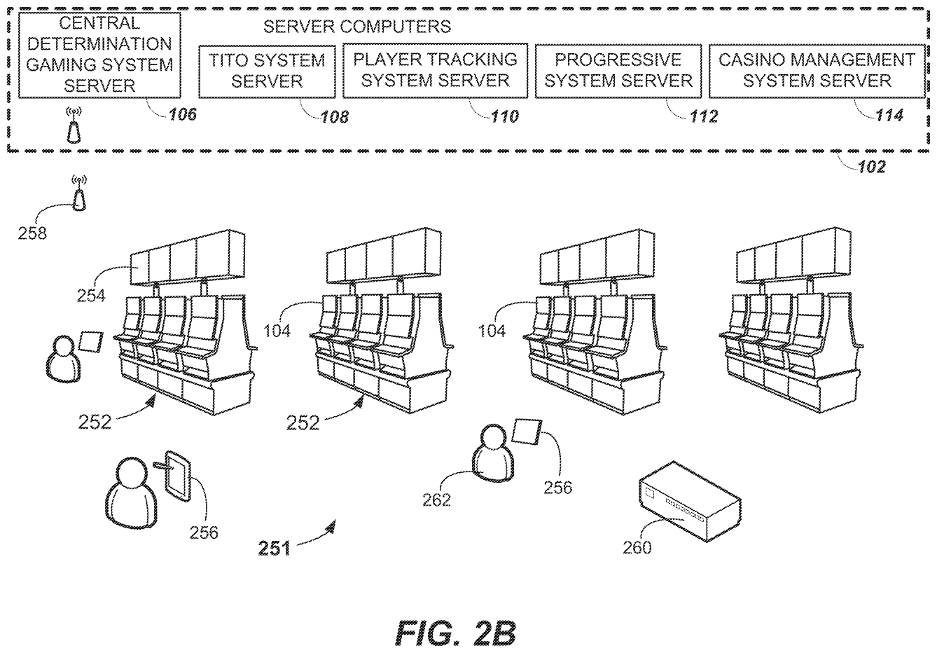

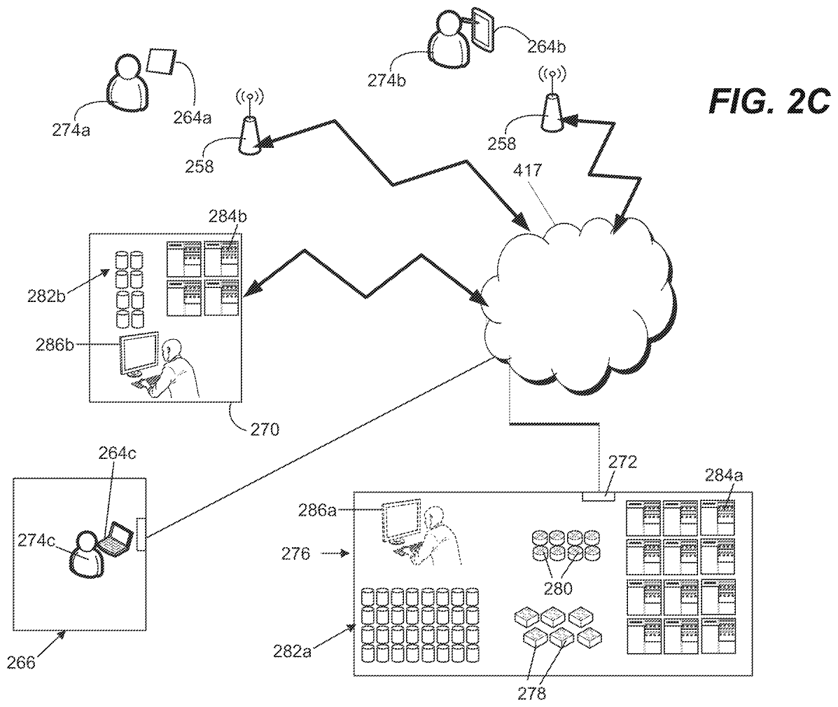

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

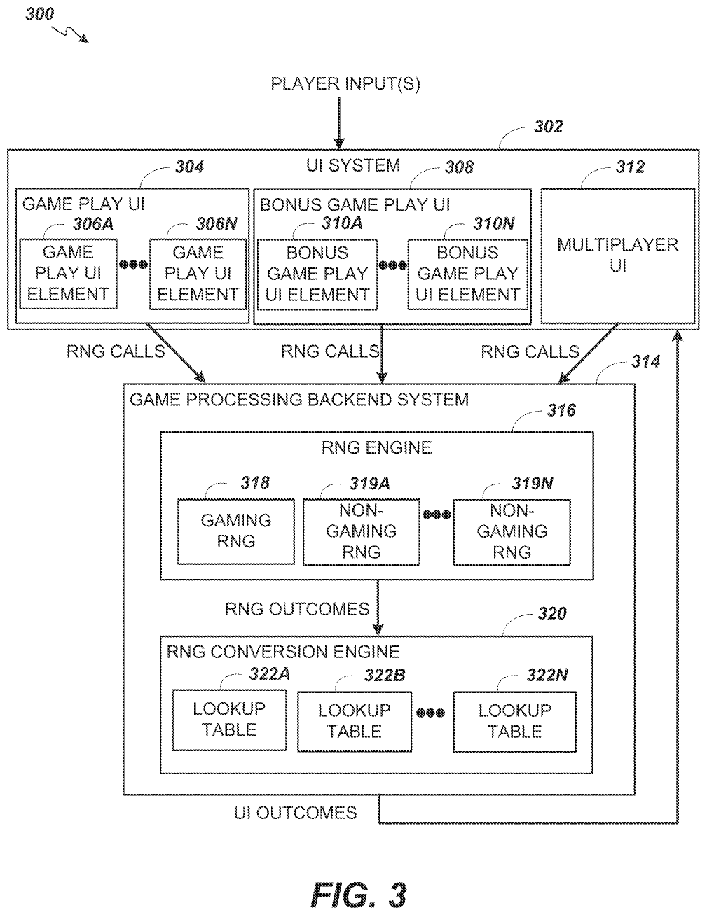

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

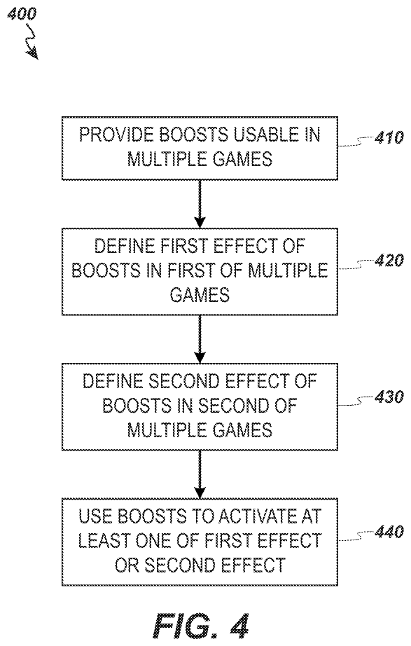

FIG. 4 depicts a first example method 400 for providing boosts for multiple games without altering return to player. The method 400 may be performed by one or more of the devices depicted in FIGS. 1-3.

At operation 410, an electronic device (such as the gaming devices 104, 104A-104X, 200 of FIGS. 1, 2A, and/or 2B, the EUD 264a, 264b and 264c of FIG. 2C, and so on) may provide one or more boosts via a user input system (such as the UI system 302 of FIG. 3) that are usable in multiple games.

For example, the multiple games may be slot type games in a virtual casino that are operable to accept wagers and/or provide prizes in a first currency, such as virtual casino chips and/or coins. The slot type games may operate on a user device (such as the mobile gaming devices 256 of FIG. 3). The slot type games may access data related to the first currency accumulated by a player that may be stored in a player account database, such as player tracking system server 110, accessible via one or more networks in order to use the first currency to make one or more wagers and/or otherwise play the slot type games. The slot type games may use a game processing system backend (such as the game processing backend 314 of FIG. 3) to select one or more stop positions for the one or more reels using a random number generator (such as the gaming RNG 318 of FIG. 3) in order to determine a game outcome, which may include providing prizes and/or other awards. The slot type games may present the game outcome via one or more game play interfaces (such as the game play UI 304 of FIG. 3). The slot type games may also update the data related to the first currency accumulated by a player that may be stored in a player account database, such as player tracking system server 110, accessible via one or more networks based on the results of the game outcome (such as incrementing the data related to the first currency based upon an award, decrementing the data related to the first currency based upon a loss, and so on).

The slot type games may also be able to provide a second currency, such as stars and/or one or more other themed currencies, usable and/or redeemable in a boost providing game to earn one or more boosts. By way of illustration, the second currency may be usable and/or redeemable in the boost providing game that is also accessible via the virtual casino to complete one or more tasks, quests (e.g., series of tasks), chapters (e.g., series of quests), and so on. Completion of such tasks, quests, chapters, and so on may earn and/or progress towards earning one or more boosts. The boost providing game may be configured such that subsequent tasks require increasingly more of the second currency to complete in order to manage player engagement with the boost providing game and/or the amount of time the player spends in the boost providing game. The boosts may then be used in the slot type games to activate one or more boost game modes (i.e., change a base game mode of the slot type games to one or more boost game modes).

In various embodiments, the progress towards completion of tasks and the boosts accumulated by a player may be stored in a player account database, such as player tracking system server 110, accessible via one or more networks. The slot type games and/or the boost providing game may access and/or update the information regarding the progress toward completion of tasks and the boosts accumulated by a player stored in a player account database, such as player tracking system server 110, accessible via one or more networks. For example, the slot type games may increment a boost count based on boosts awarded and/or collected, decrement a boost count based on boosts used, and so on. Such information regarding the completion of tasks and the boosts accumulated by a player may be stored in a player account database, such as player tracking system server 110, accessible via one or more networks may be separately stored from the data related to the first currency accumulated by a player, stored together with the data related to the first currency accumulated by a player, and so on. Various configurations are possible and contemplated without departing from the scope of the present disclosure.

In various examples, each spin of each slot type game may involve chances of different types of awards of the first currency that may be determined based upon the game outcome. The awards may be determined using one or more payout tables, which may be different for one or more of the slot type games. The awards may be dependent upon an amount wagered, such that increased chances of awards and/or increased sizes of awards may be available for increased amounts wagered.

Boosts may also be awarded in correspondence to amounts wagered, whether on each spin of each slot type game, an accumulation of wagers of spins of slot type games, and so on. In other words, boosts may be credited based on a volume of wagers. By way of illustration, a boost may be awarded for every 500,000 wagered in the first currency. However, it is understood that this is an example. In other implementations, other amounts of boosts may be awarded for other amounts wagered.

Though boosts may be awarded in correspondence to amounts wagered, the boosts awarded may not be immediately made available to players. Instead, the players may collect the boosts that have been awarded by completing tasks in the boost providing game.

By way of illustration, a first player may have been awarded 10 boosts. Upon subsequently completing a task in the boost providing game, the first player may be provided the 10 boosts. However, a second player may have been awarded 5 boosts. Upon subsequently completing a task in the boost providing game, the first player may be provided the 5 boosts. Various configurations are possible and contemplated without departing from the scope of the present disclosure.

Each spin of each slot type game may also have a chance of awarding the second currency. This may be determined using a random number generator (such as the gaming RNG 318 of FIG. 3). Upon determining that a player has been awarded the second currency, a determination may be made regarding the amount of the second currency awarded. For example, there may be a 1% chance that 1 of the second currency is awarded, a 2% chance that 2 of the second currency is awarded, a 0.011% chance that 10 of the second currency is awarded, and so on. This may also be determined using a random number generator (such as the gaming RNG 318 of FIG. 3), and this determination may be dependent upon and/or independent of the determination to award the second currency. Various configurations are possible and contemplated without departing from the scope of the present disclosure.

In some implementations, the chance of awarding the second currency and/or the amount awarded may be independent of an amount wagered. In other implementations, the chance of awarding the second currency and/or the amount awarded may increase as amounts wagered increase. However, in various such implementations, the chance of awarding the second currency and/or the amount awarded may increase by small amounts as amounts wagered increase. Such small amounts may be less than the chance of and/or the amount of awards of the first currency increase as amounts wagered increase. Various configurations are possible and contemplated without departing from the scope of the present disclosure.

By way of an illustrative example, a player may earn 10 boosts and 5 of the second currency by wagering 3 million in the first currency in a first slot type game and 2 million in the first currency in a second slot type game. The player may then collect these 10 boosts by using 3 of the second currency to complete a task in the boost collecting game and subsequently use 1 of these 10 boosts in the first slot type game, 2 of these boosts in the second slot type game, and 7 of these boosts in a third slot type game. Various configurations are possible and contemplated without departing from the scope of the present disclosure.

At operation 420, the electronic device may define a first effect of the boosts in a first game of the multiple games. The electronic device may define the first effect of the boost in the first game by specifying the first effect in the code of the first game. By way of example, the first effect may be a first prize multiplier that multiplies prizes in the first game by a first amount.

However, it is understood that this is an example. In other implementations, the effect may be any other kind of effect, such as adding one or more symbols to one or more reels, making one or more symbols wild, providing one or more free games, unlocking one or more locked features, providing extra symbols, and so on. Various configurations are possible and contemplated without departing from the scope of the present disclosure. In various configurations, effects of boosts may be stored as altered game logic in memory. In various configurations, effects of boosts may be stored as different RNG conversion engines 320, that when used in conjunction with game logic, result in the boost.

At operation 430, the electronic device may define a second effect of the boosts in a second game of the multiple games. The electronic device may define the second effect of the boost in the second game by specifying the second effect in the code of the first game. By way of example, the first effect may be a second prize multiplier that multiplies prizes in the second game by a second amount.

At operation 440, the electronic device may use the boosts to activate at least one of the first effect or the second effect. For example, the electronic device may receive user input via a user input system (such as the UI system 302 of FIG. 3) during play of the first game or the second game to use the boosts to activate the first effect or the second effect. The electronic device may determine the effect of activating the boosts according to the contents of the game being played and apply the determined effect. The electronic device may then present the outcome of the game after applying the determined effect via a user interface (such as the bonus game play UI 308 of FIG. 3).

By way of example, the first game and the second game may each define a base game return to player and one or more boost game return to players that may be activated by using one or more different numbers of boosts. For example, the first game may define a first boost game return to player that corresponds to a 5 times prize multiplier activatable using 100 boosts and a second boost game return to player that corresponds to a 10 times prize multiplier activatable using 500 boosts while the second game may define a third boost game return to player that corresponds to a 20 times prize multiplier activatable using 300 boosts and a second boost game return to player that corresponds to a 30 times prize multiplier activatable using 1000 boosts. Each of the first game and the second game may be configured such that the base game return to players are the same and/or substantially the same (i.e., the ratio between the return to players are within 100.5%) and/or that the various boost game return to players are the same and/or substantially the same. Thus, as the first game and the second game define their various return to players and the effect of the boosts to achieve those return to players, the electronic device may provide boosts that are usable in multiple games without altering the return to player established by those games and/or an overall target RTP associated with an amount wagered that corresponds to the award of the boosts. Altering return to player may be prohibited by one or more laws and/or regulations.

In various examples, this example method 400 may be implemented as a group of interrelated software modules or components that perform various functions discussed herein. These software modules or components may be executed within a cloud network and/or by one or more computing devices, such as the gaming devices 104, 104A-104X, 200 of FIGS. 1, 2A, and/or 2B, the EUD 264a, 264b and 264c of FIG. 2C, and so on.

Although the example method 400 is illustrated and described as including particular operations performed in a particular order, it is understood that this is an example. In various implementations, various orders of the same, similar, and/or different operations may be performed without departing from the scope of the present disclosure.

For example, the above illustrates and describes the electronic device defining the first effect and the second effect. However, it is understood that this is an example and that in other implementations the first effect and/or the second effect may already be defined by the first game and/or the second game and the electronic device may determine and/or otherwise access data regarding the first effect and/or the second effect, such as by accessing code and/or other data for the first game and/or the second game. Various configurations are possible and contemplated without departing from the scope of the present disclosure.

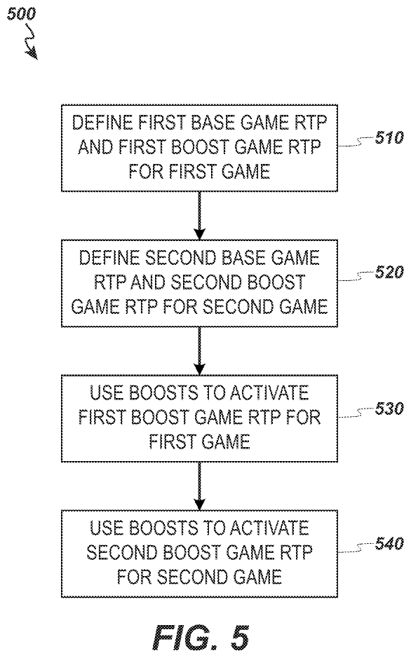

FIG. 5 depicts a second example method 500 for providing boosts for multiple games without altering return to player. The method 500 may be performed by one or more of the devices depicted in FIGS. 1-3.

At operation 510, an electronic device (such as the gaming devices 104, 104A-104X, 200 of FIGS. 1, 2A, and/or 2B, the EUD 264a, 264b and 264c of FIG. 2C, and so on) or a gaming server may define a first base game return to player and a first boost game return to player for a first game to be stored in a memory or a data structure in a database accessible via a network. For example, the electronic device may define a first boost game return to player for the first game that corresponds to a 3 times prize multiplier activatable using 400 boosts and a second boost game return to player for the first game that corresponds to a 7 times prize multiplier activatable using 700 boosts.

At operation 520, the electronic device may define a second base game return to player and a second boost game return to player for a second game to be stored in a memory or a data structure in a database accessible via a network. For example, the electronic device may define a third boost game return to player for the second game that corresponds to a 2 times prize multiplier activatable using 700 boosts and a second boost game return to player for the second game that corresponds to a 6 times prize multiplier activatable using 1500 boosts. The electronic device may be configured such that the base game return to players for the first game and the second game are the same and/or substantially the same (i.e., the ratio between the return to players are within 100.5%) and/or that the various boost game return to players are the same and/or substantially the same. Thus, as the electronic device defines the various return to players for the first game and the second game and the effect of the boosts to achieve those return to players, the electronic device may provide boosts that are usable in multiple games without altering the return to player of those games and/or an overall target RTP associated with an amount wagered that corresponds to the award of the boosts. Altering return to player may be prohibited by one or more laws and/or regulations.

At operation 530, the electronic device may use boosts to activate the first boost game return to player for the first game. For example, the electronic device may maintain data in a non-transitory storage medium regarding a total number of boosts that have been earned by a player and/or otherwise awarded to the player and/or access data stored in a memory or a data structure in a database accessible via a network. During play of the first game, the electronic device may receive user input from the player regarding using a first amount of the boosts. In response, the electronic device may determine that the data indicates that the player has the first amount of boosts, decrement the first amount of the boosts from the data, and apply the first amount of the boosts to the first game to activate a first effect, which may change the first game from a base game mode to a boost game mode, as well as changing from a base game return to player for the first game to a boost game return to player for the first game.

At operation 540, the electronic device may use boosts to activate the second boost game return to player for the second game. For example, during play of the second game, the electronic device may receive user input from the player regarding using a second amount of the boosts. In response, the electronic device may determine that the data indicates that the player has the second amount of boosts, decrement the second amount of the boosts from the data, and apply the second amount of the boosts to the second game to activate a second effect, which may change the second game from a base game mode to a boost game mode, as well as changing from a base game return to player for the second game to a boost game return to player for the second game. The electronic device may update data in a non-transitory storage medium regarding a total number of boosts that have been earned by a player and/or otherwise awarded to the player and/or access data stored in a memory or a data structure in a database accessible via a network to decrement a total number of boosts that have been earned by a player and/or otherwise awarded to the player based on boosts used.

In various examples, this example method 500 may be implemented as a group of interrelated software modules or components that perform various functions discussed herein. These software modules or components may be executed within a cloud network and/or by one or more computing devices, such as the gaming devices 104, 104A-104X, 200 of FIGS. 1, 2A, and/or 2B, the EUD 264a, 264b and 264c of FIG. 2C, and so on.

Although the example method 500 is illustrated and described as including particular operations performed in a particular order, it is understood that this is an example. In various implementations, various orders of the same, similar, and/or different operations may be performed without departing from the scope of the present disclosure.

For example, the above illustrates and describes the electronic device defining the first base game return to player, the first boost game return to player, the second base game return to player, and the second boost game return to player. However, it is understood that this is an example and that in other implementations the first base game return to player, the first boost game return to player, the second base game return to player, and/or the second boost game return to player may already be defined by the first game and/or the second game and the electronic device may determine and/or otherwise access data regarding the first base game return to player, the first boost game return to player, the second base game return to player, and/or the second boost game return to player, such as by accessing code and/or other data for the first game and/or the second game. Various configurations are possible and contemplated without departing from the scope of the present disclosure.

Although the above is illustrated and described as defining different base game RTPs and boost game RTPs for the first and second games, it is understood that this is an example. In various implementations, the first and second games may have the same overall RTPs, but may use different mechanisms to accomplish such (such as by having different award frequencies, award amounts, and so on). By allowing the first and second games to define the effect of boosts, the present disclosure may prevent the boosts from having differing effects on the first and second games to accomplish their RTPs and thus may prevent the boosts from changing the RTPs of the first and second games. Various configurations are possible and contemplated without departing from the scope of the present disclosure.

Further, the base game RTPs and the boost game RTPs may be part of the same overall RTPs. This may be due to the boosts being a way to delay the RTP to return wagered first currency through the boosts that would otherwise be accomplished in the base game had the system of boosts not been utilized. Various configurations are possible and contemplated without departing from the scope of the present disclosure.

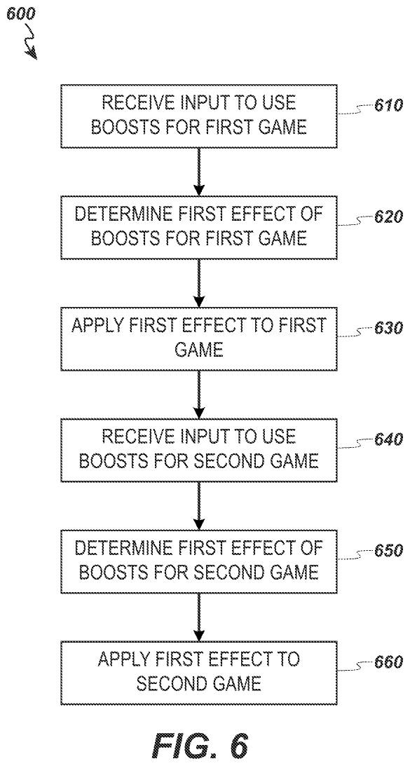

FIG. 6 depicts a third example method 600 for providing boosts for multiple games without altering return to player. The method 600 may be performed by one or more of the devices depicted in FIGS. 1-3.

At operation 610, an electronic device (such as the gaming devices 104, 104A-104X, 200 of FIGS. 1, 2A, and/or 2B, the EUD 264a, 264b and 264c of FIG. 2C, and so on) may receive input to use boosts for a first game. For example, the first game may control a display to present a boost inventory indicator that may be selected to control the display to present a boost inventory, and the boost inventory may include one or more boost indicators that may be selected to use a first amount of boosts for the first game.

At operation 620, the electronic device may determine a first effect of the boosts for the first game. For example, the electronic device may access data for the first game that specifies the first effect.

At operation 630, the electronic device may apply the first effect to the first game. For example, the first effect may be a 10 times prize multiplier that may be multiplied against any prize awarded in the next 16 plays (and/or another fixed amount of plays) of the first game. As such, the electronic device may multiply any prize awarded in the next 16 plays of the first game by 10.

At operation 640, the electronic device may receive input to use the boosts for a second game. For example, the second game may control a display to present a boost inventory indicator that may be selected to control the display to present a boost inventory, and the boost inventory may include one or more boost indicators that may be selected to use a second amount of boosts for the second game.

At operation 650, the electronic device may determine a second of the boosts for the second game. For example, the electronic device may access data for the first game that specifies the second effect.

At operation 660, the electronic device may apply the second effect to the second game. For example, the first effect may be a 5 times prize multiplier that costs 100 boosts and may be multiplied against any prize awarded in the next 14 plays of the first game. As such, the electronic device may decrement the boost inventory by 100 boosts and multiply any prize awarded in the next 15 plays of the first game by 5.

In various examples, this example method 600 may be implemented as a group of interrelated software modules or components that perform various functions discussed herein. These software modules or components may be executed within a cloud network and/or by one or more computing devices, such as the gaming devices 104, 104A-104X, 200 of FIGS. 1, 2A, and/or 2B, the EUD 264a, 264b and 264c of FIG. 2C, and so on.

Although the example method 600 is illustrated and described as including particular operations performed in a particular order, it is understood that this is an example. In various implementations, various orders of the same, similar, and/or different operations may be performed without departing from the scope of the present disclosure.

For example, the above illustrates and describes receiving input to use boosts for both the first and second game, determining first and second effects, applying the first effect to the first game, and applying the second effect to the second game. However, it is understood that this is an example and that in other implementations one or more of these operations may be omitted and/or other operations may be performed. By way of example, in some implementations, input may be received to use boosts for the first game and not the second game. By way of another example, in a number of implementations, input may be received to use boosts for the first game, the second game, and a third game. Various configurations are possible and contemplated without departing from the scope of the present disclosure.

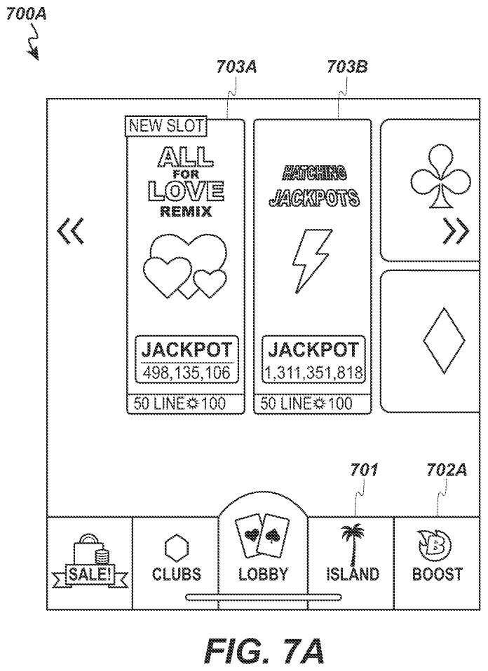

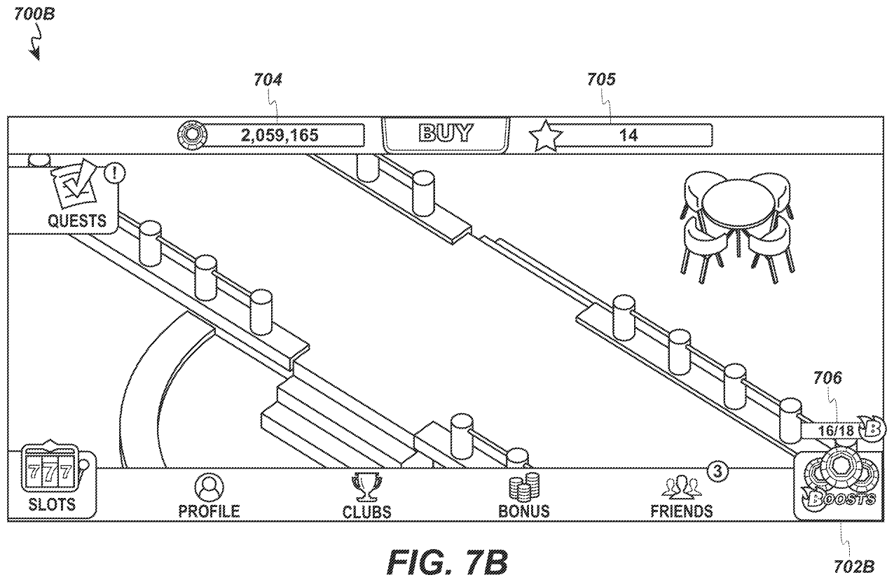

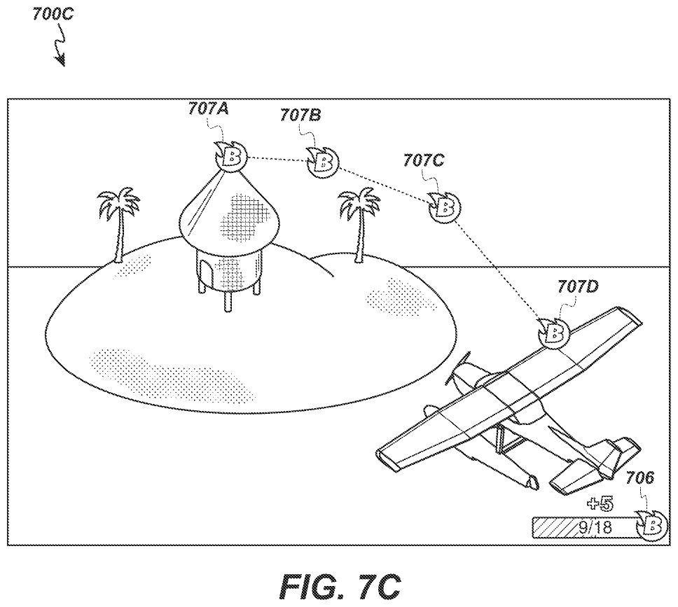

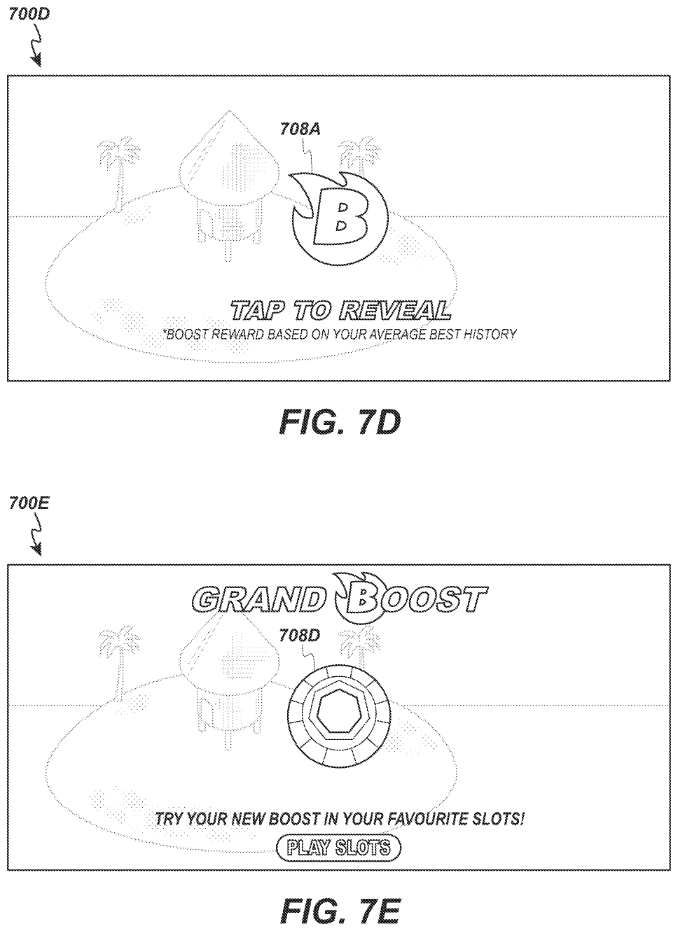

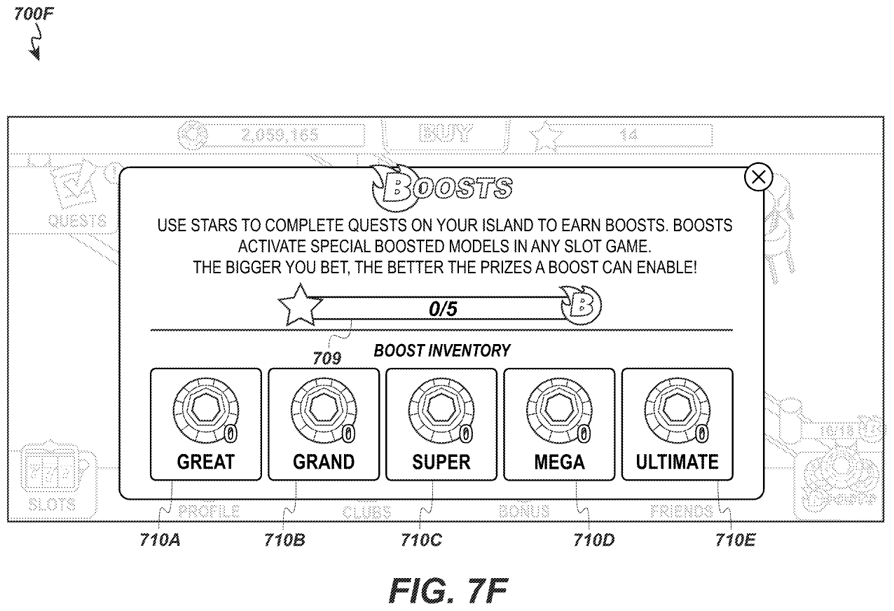

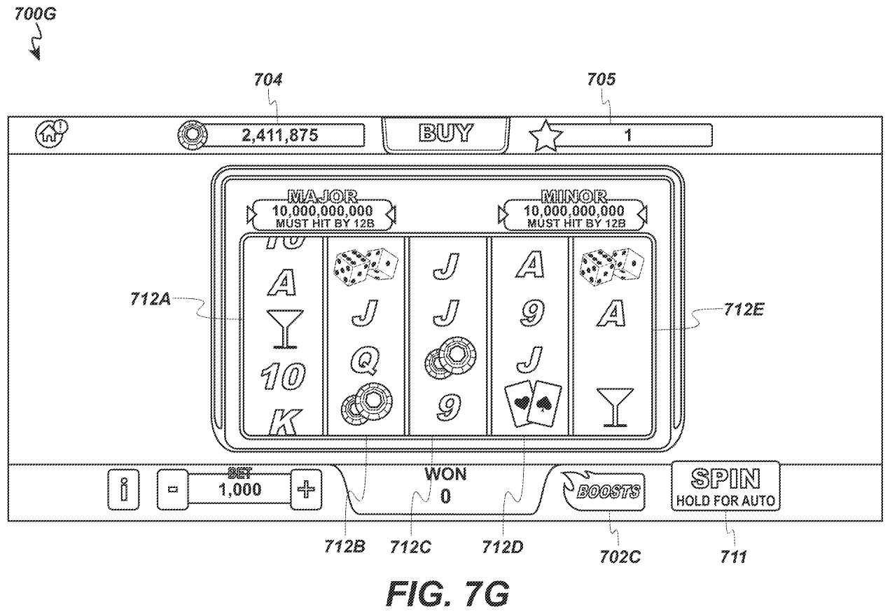

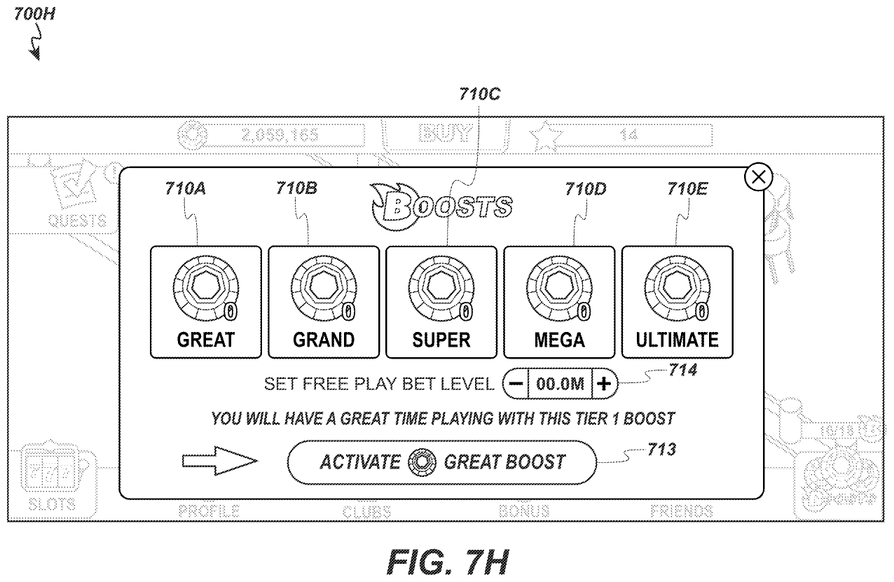

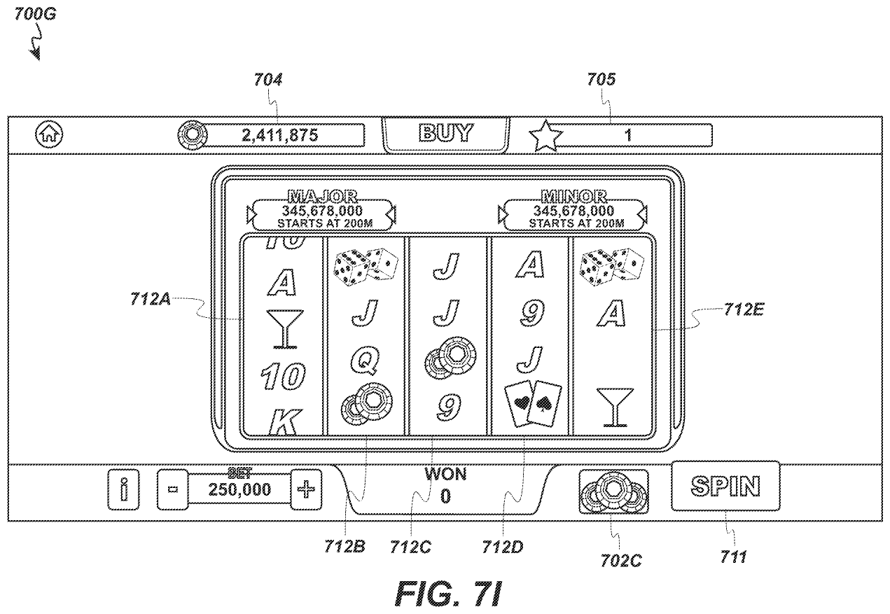

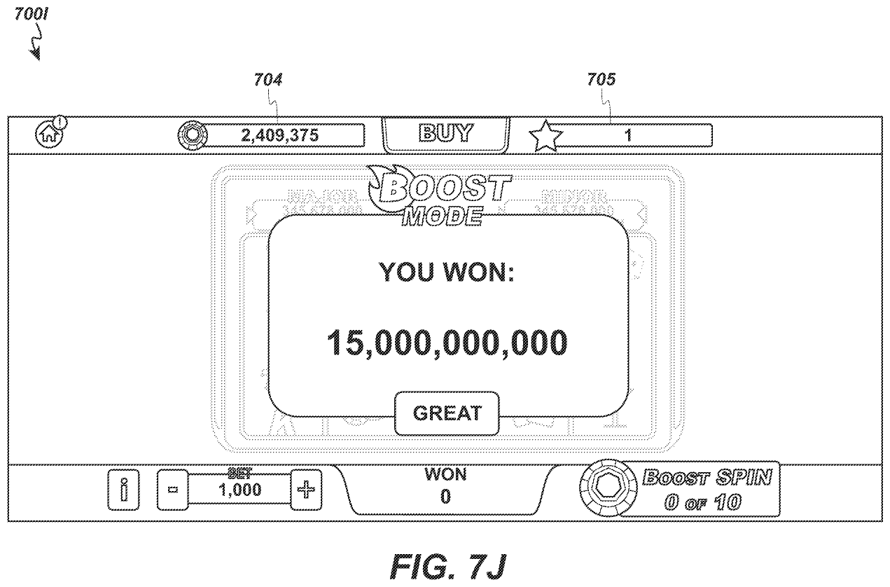

FIG. 7A depicts a lobby of a virtual casino environment 700A that is operable to provide access to multiple games 703A, 703B that are operable to use boosts and at least one indicator 701 operable to launch one or more boost providing games (which may be an island boost providing game in some examples). The virtual casino environment 700A may be an app that executes on a mobile computing device. The app may obtain and/or execute code and/or other software from one or more server computing devices for the multiple games 703A, 703B, the boost providing game, and so on.

For example, the multiple games 703A, 703B may include one or more slot type games that are operable to accept wagers and/or provide prizes in a first currency, such as virtual casino chips and/or coins. Players may be able to earn free virtual casino chips and/or coins in the virtual casino environment 700A, purchase virtual casino chips and/or coins, and so on. The slot type games may use a game processing system backend (such as the game processing backend 314 of FIG. 3) to select one or more stop positions for the one or more reels using a random number generator (such as the gaming RNG 318 of FIG. 3) in order to determine a game outcome, which may include providing prizes and/or other awards. The slot type games may present the game outcome via one or more game play interfaces. The slot type games may also be able to provide a second currency, such as stars and/or one or more other themed currencies, usable and/or redeemable in a boost providing game to earn one or more boosts. By way of illustration, the second currency may be usable and/or redeemable in the boost providing game to complete one or more tasks, quests (e.g., series of tasks), chapters (e.g., series of quests), and so on. Completion of such tasks, quests, chapters, and so on may earn and/or progress towards earning one or more boosts. The boosts may then be used in the slot type games to activate one or most boost game modes (i.e., change a base game mode of the slot type games to one or more boost game modes).

The lobby of a virtual casino environment 700A may also include one or more indicators 702A that are operable to cause a display to present and/or animate a boost inventory. Such a boost inventory may include information regarding the total number of boosts that a player has earned and/or been awarded. An example of such a boost inventory is shown in FIG. 7F.

FIG. 7B depicts a lobby 700B of the boost providing game. The lobby 700B may display a number of indicators that indicate the amount of one or more currencies that a player has accumulated, such as the indicator 704 that depicts the amount of the first currency, such as virtual casino chips and/or coins, that the player has accumulated; the indicator 705 that depicts the amount of the second currency, such as stars and/or one or more other themed currencies, that the player has accumulated; and so on. The lobby 700B may also include one or more progress bars 706 that depict the player's progress toward a next boost, as well as one or more indicators 702B that are operable to cause a display to present and/or animate a boost inventory. A player may be able to use the lobby 700B to enter one or more other parts of the boost providing game as part of playing the boost providing game.

FIG. 7C depicts play 700C of the boost providing game. As shown, this may include a number of tasks, quests (e.g., series of tasks), chapters (e.g., series of quests), and so on that a player may complete to earn one or more boosts 707A-707D. This may also include one or more progress bars 706 that depict the player's progress toward a next boost. A player may spend one more accumulated currencies, such as stars and/or one or more other themed currencies, to complete one or more of the tasks. For example, a quest may include obtaining rescue from a deserted island. Such a quest may include a series of tasks like building a shelter (which may earn the boost 707A), obtaining food from a coconut palm (which may earn the boost 707B), lighting a signal flare (which may earn the boost 707C), and getting the attention of a rescue plane (which may earn the boost 707D).

Upon the player earning and/or otherwise being awarded a boost, the boost providing game may control a display to provide one or more animations related to the boost. For example, FIG. 7D depicts a first screen 700D of the boost providing game providing a boost 708A. As shown, the first screen 700D may specify that a boost 708A has been awarded, but may prompt the player to tap and/or otherwise provide input to reveal the amount of the boost 708A. FIG. 7E depicts a second screen 700E of the boost providing game providing a boost 708E. 700D This second screen 700E may be presented and/or animated after the player has tapped and/or otherwise provided input from the first screen 700D of FIG. 7D to reveal the amount of the boost 708D.

FIG. 7F depicts a boost inventory screen 700F accessed from the lobby 700B of the boost providing game depicted in FIG. 7B. The boost inventory screen 700F may be presented and/or animated by a display in response to selection of the indicator 702B of FIG. 7B. The boost inventory may include information regarding an amount of boosts 710A-710E that a player has accumulated, as well as one or more progress bars 709 that depict the player's progress toward a next boost. However, the boost inventory screen 700F may not explain the effect of the boosts 710A-710E. This may be because the effect of the boosts 710A-710E may be independently defined for each of the multiple games that are operable to use boosts and, as such, may not be defined in the context of the boost inventory screen 700F accessed from the lobby 700B of the boost providing game depicted in FIG. 7B.

FIG. 7G depicts play of a game 700G of the multiple games that are operable to use boosts. The game 700G may be a slot type game that is operable to accept wagers and/or provide prizes in a first currency, such as virtual casino chips and/or coins. In response to a player initiating play by selecting a spin and/or other indicator 711, the game 700G may use a game processing system backend (such as the game processing backend 314 of FIG. 3) to select one or more stop positions for the one or more reels 712A-712E using a random number generator (such as the gaming RNG 318 of FIG. 3) in order to determine a game outcome, which may include providing prizes and/or other awards. The game 700G may present and/or animate the game outcome via one or more game play interfaces. The game 700G may also be able to provide a second currency, such as stars and/or one or more other themed currencies, usable and/or redeemable in a boost providing game to earn one or more boosts. Further, the game 700G may include a boost inventory indicator 702C.

In various examples, each slot game will use a number (predetermined or randomly determined) of spins to award a star. This may not depend on the wager amount, or wager size. The backend server may track a total wager pool and total star pool per player. The total wager pool is the total amount wagered by the player and the total star pool is the total mount of stars accumulated by the player. This may be tracked individually per slot game and/or for all slot games played in the casino application.

In various examples, after collecting stars, the player may complete one or more tasks that earn boosts. A certain quantity of stars may be needed to complete a task. Further, tasks may be sequential, i.e., after completing a task, another one is made available. Tasks may be parallel, i.e., a player may be able to complete multiple tasks. After the completion of a predetermined quantity of tasks, one or more boosts may be awarded to the player. These boosts are stored in a field in a table associated with the player, in a backend server.

In various examples, the value of a boost may be represented by a fair coin value, which is a percentage of the total amount wagered by the player to obtain the boost. Various slot games may be designed such that the RTP of the boost mode is either fixed or proportional to the fair coin value of the boost used to trigger the boost mode. In cases where the RTP of the boost mode is fixed, the quantity of boosts needed to trigger the boost mode may be adjusted to achieve proportionality. In this manner, a new technical improvement is provided that allows the value of a boost to be variable, depending on factors such as the amount of coin wagered, stars collected, stars consumed, etc.

FIG. 7H depicts a boost inventory screen 700H accessed from the game depicted in FIG. 7G, such as by selecting the boost inventory indicator 702C of FIG. 7G that is operable to cause a display to present and/or animate a boost inventory. The boost inventory may include information regarding an amount of boosts 710A-710E that a player has accumulated, as well as one or more indicators that explain the effect of the boosts 710A-710E within the context of the game 700G of FIG. 7G. This may be because the effect of the boosts may be independently defined for each of the multiple games that are operable to use boosts and, as such, are defined in the context of the boost inventory screen 700H accessed from the game 700G of FIG. 7G. The boost inventory screen 700H may also include one or more indicators 713 that a player may select to activate and/or otherwise use one or more of the boosts 710A-710E within the context of the game 700G of FIG. 7G. The boost inventory screen 700H may also include one or more indicators 714 that a player may toggle and/or otherwise manipulate to adjust the player's bet up and down before activating and/or otherwise using one or more of the boosts 710A-710E within the context of the game 700G of FIG. 7G.

FIG. 7I depicts a boost game mode of the game 700G depicted in FIG. 7G. This boost game mode, which may be a bonus game, may be presented after a player selects and/or otherwise uses one or more of the boosts 710A-710E within the context of the game 700G of FIG. 7G by selecting the indicator 713. As shown, the icon for the boost inventory indicator 702C has been changed from FIG. 7G to indicate that the boost game mode is active. The boost game mode may apply an effect defined by the game 700G for a fixed number of spins, such as a 5 times prize multiplier for each prize awarded during ten boost game mode spins.

FIG. 7J depicts a boost game mode summary 7001 at the end of the boost game mode depicted in FIG. 7I. As shown, the boost game mode summary 7001 may specify a cumulative prize amount that the player has been awarded during the boost game mode.

Although the above illustrates and describes a number of embodiments, it is understood that these are examples. In various implementations, various techniques of individual embodiments may be combined without departing from the scope of the present disclosure.

As discussed above, the present disclosure provides boosts that may be used in multiple different games, but enables the effect of the boosts to be respectively defined in each of the different games. Each game may define a base game mode and one or more boost game modes that one or more amounts of boosts may be used to activate. In this way, boosts may be provided for multiple different games without altering the return to player that has been respectively defined by each of the multiple games.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system, comprising:
a memory that stores instructions; and
a processor that executes the instructions to:
provide boosts that are usable in multiple games corresponding to an amount wagered as part of achieving an overall target return to player (RTP);
store data regarding the boosts in a player account database accessible via at least one network;
define a first effect of the boosts in a first game of the multiple games that maintains the overall target RTP;
define a second effect of the boosts in a second game of the multiple games that maintains the overall target RTP;
use the boosts to activate at least one of the first effect or the second effect; and
communicate with the player account database via the at least one network to update the player account database for the use of the boosts.

2. The system of claim 1, wherein the first effect is to multiply prizes in the first game a first amount.

3. The system of claim 2, wherein the second effect is to multiply prizes in the second game a second amount.

4. The system of claim 1, wherein:
first code of the first game defines the first effect; and
second code of the second game defines the second effect.

5. The system of claim 1, wherein the first game and the second game have a same first return to player prior to activation of the first effect or the second effect.

6. The system of claim 1, wherein the processor provides the boosts via a third game that is separate from the multiple games.

7. The system of claim 1, wherein the first game and the second game have a same second return to player after activation of the first effect and the second effect.

8. A method, comprising:
providing, using at least one processor, boosts that are usable in multiple games corresponding to an amount wagered as part of achieving an overall target return to player (RTP);
storing, using at least one processor, data regarding the boosts in a player account database accessible via at least one network;
defining, using at least one processor, a first base game return to player in first code for a first game that maintains the overall target RTP;
defining, using at least one processor, a first boost game return to player in second code for the first game that maintains the overall target RTP;
defining, using at least one processor, a second base game return to player in third code for a second game that maintains the overall target RTP;
defining, using at least one processor, a second boost game return to player in fourth code for the second game that maintains the overall target RTP;
using, using at least one processor, a first amount of the boosts to activate the first boost game return to player for the first game;
using, using at least one processor, a second amount of the boosts to activate the second boost game return to player for the second game; and
communicating with the player account database via the at least one network to update the player account database for the first amount of the boosts and the second amount of the boosts.

9. The method of claim 8, further comprising defining:
a third boost game return to player in fifth code for the first game; and
a fourth boost game return to player in sixth code for the second game.

10. The method of claim 9, further comprising:
using a third amount of the boosts to activate the third boost game return to player for the first game;
using a fourth amount of the boosts to activate the fourth boost game return to player for the second game; and
communicating with the player account database via the at least one network to update the player account database for the third amount of the boosts and the fourth amount of the boosts.

11. The method of claim 10, further comprising using:
the first amount of the boosts to multiply first prizes in the first game by a first number; and
the second amount of the boosts to multiply second prizes in the second game by a second number.

12. The method of claim 11, further comprising using:
the third amount of the boosts to multiply the first prizes in the first game by a third number; and
the fourth amount of the boosts to multiply the second prizes in the second game by a fourth number.

13. The method of claim 8, wherein the first game and the second game are each operable to award prizes in a first currency and a second currency.

14. The method of claim 13, wherein:
the first game and the second game each accept wagers in the first currency; and
the second currency is redeemable for the boosts.

15. A computer program product, comprising:
first instructions that are stored in at least one non-transitory computer readable medium and are executable by at least one processor to receive first user input to apply a first amount of boosts for a first game, the boosts provided corresponding to an amount wagered as part of achieving an overall target return to player (RTP), data regarding the boosts accessed from a player account database via at least one network;
second instructions that are stored in the at least one non-transitory computer readable medium and are executable by the at least one processor to determine a first effect of the first amount of the boosts in the first game, the first effect configured to maintain the overall target RTP;
third instructions that are stored in the at least one non-transitory computer readable medium and are executable by the at least one processor to apply the first effect to the first game;
fourth instructions that are stored in the at least one non-transitory computer readable medium and are executable by the at least one processor to receive second user input to apply a second amount of the boosts for a second game;
fifth instructions that are stored in the at least one non-transitory computer readable medium and are executable by the at least one processor to determine a second effect of the second amount of the boosts in the second game, the second effect configured to maintain the overall target RTP; and
sixth instructions that are stored in the at least one non-transitory computer readable medium and are executable by the at least one processor to apply the second effect to the second game.

16. The computer program product of claim 15, further comprising seventh instructions that are stored in the at least one non-transitory computer readable medium and are executable by the at least one processor to control a display to present:
a first indicator explaining the first effect in the first game; and
a second indicator explaining the second effect in the second game.

17. The computer program product of claim 15, further comprising seventh instructions that are stored in the at least one non-transitory computer readable medium and are executable by the at least one processor to determine:
the first effect of the first amount of the boosts in the first game by consulting first code of the first game; and
the second effect of the second amount of the boosts in the second game by consulting second code of the second game.

18. The computer program product of claim 15, further comprising seventh instructions that are stored in the at least one non-transitory computer readable medium and are executable by the at least one processor to award the boosts in response to completion of tasks in a third game.

19. The computer program product of claim 15, wherein the first effect lasts in the first game for a fixed amount of plays.

20. The computer program product of claim 19, further comprising seventh instructions that are stored in the at least one non-transitory computer readable medium and are executable by the at least one processor to control a display to present a summary of the first effect after the fixed amount of plays.
